(19) United States
(12) Patent Application Publication
(10) Pub. No.: US 2019/0124222 A1
(43) Pub. Date: Apr. 25, 2019

(54) ADAPTOR FOR IMAGE SCANNER AND IMAGE SCANNER

(71) Applicant: NIDEC SANKYO CORPORATION, Suwa-gun Nagano (JP)

(72) Inventors: Teruo MATSUE, Suwa-gun Nagano (JP); Toshio TATAI, Suwa-gun Nagano (JP)

(21) Appl. No.: 16/166,482

(22) Filed: Oct. 22, 2018

Related U.S. Application Data
(60) Provisional application No. 62/574,987, filed on Oct. 20, 2017.

(30) Foreign Application Priority Data
Mar. 27, 2018 (JP) 2018-059196

(51) Int. Cl. H04N 1/00; H04N 1/203

(52) U.S. Cl. CPC H04N 1/00615; H04N 1/203

(57) ABSTRACT

An adapter for an image scanner, the image scanner being structured to convey a card, and the adapter being structured so that a front surface and a back surface of a card-shaped medium thinner than the card are read by the image scanner, the adapter may include a first sheet which is transparent and longer than a length of the card, and the card-shaped medium being placed on a front surface of the first sheet; a spacer having a constant thickness which is transparent and fixed to at least one of a front end portion and a rear end portion of the front surface of the first sheet; and a second sheet which is transparent and fixed to the spacer so as to be overlapped with the first sheet, and the second sheet covering the card-shaped medium from an opposite side to the first sheet.

### CROSS REFERENCE TO RELATED APPLICATION

The present application claims priority under 35 U.S.C. § 119 to Japanese Application No. 2018-059196 filed Mar. 27, 2018, the entire content of which is incorporated herein by reference. The present application also claims priority under 35 U.S.C. § 119 to U.S. Provisional Application No. 62/574,987, filed Oct. 20, 2017, the disclosure of which is incorporated herein by reference.

### TECHNICAL FIELD

At least an embodiment of the present invention may relate to an adapter for an image scanner structured to read an image of a card-shaped medium such as a paper thinner than a plastic card. Further, at least an embodiment of the present invention may relate to an image scanner structured to acquire an image of a card by using an adapter for an image scanner.

### BACKGROUND

An image reading device structured to read an image of a medium such as an ID card, for example, an automobile driver's license, a credit card, a my-number card, on which personal information is written, has spread. Especially, by introduction of My-Number System in Japan, utilization of an image reading device has been expanded at a counter of a bank or the like for confirming the individual by an image of a card.

The image reading device is a device structured to read a card-shaped medium whose outer shape is the same as that of a credit card or the like of ID-1 (JIS ID-1) of ISO standards and scan an image by an image sensor disposed in a conveyance path while conveying the card-shaped medium. Further, in this type of image reading device, images of a plurality of types of cards whose outer shapes are the same but whose thicknesses are different may be required to read. For example, there may be a case that a paper card (notification card for notifying my-number or the like) is required to read which is obtained by cutting out an inner side of a cut line from a mount where a card-shaped cut line is printed by a user in a thin paper whose thickness is 0.1 mm through 0.2 mm.

A paper card is operated so that each individual cuts out and uses it as required and thus its outer shape becomes often uneven. A paper card whose outer shape is not uniform is used in the above-mentioned image reading device, an edge of the paper card may be wrinkled and damaged during conveyance. Further, when a cut end face of a card is distorted, an image reading device cannot recognize a reference for reading an image and thus a reading error may be occurred. In order to prevent the problems, a measure has been performed that a paper punch dedicated for an ISO card shape is prepared in a place using a scanner (public office and store) for aligning an outer shape of a paper card of a cutting-out system and, when a user having a paper card without being cut out has come, the paper card is cut neatly in the ISO size and then processing is performed. However, a work for aligning a size is complicated and a dedicated jig (punch) is also required.

In Patent Literature 1 (Japanese Patent Laid-Open No. 2016-155345), a technique is disclosed that a card-shaped medium is held by an adapter and conveyed to a printer when a thin card-shaped medium such as a paper card is to be printed by the printer.

Also in an image reading device (image scanner), in order to avoid damage and clogging during conveyance of a thin card-shaped medium, it is conceivable that a card-shaped medium is held by an adapter or the like and is conveyed.

### SUMMARY

In view of the problem described above, at least an embodiment of the present invention may advantageously provide an adapter for an image scanner by which a card-shaped medium is capable of being read by the image scanner without occurring clogging of the card-shaped medium during conveyance and without damaging the card-shaped medium even when a shape of the card-shaped medium which is thinner than a card of a predetermined standard is uneven. Further, at least an embodiment of the present invention may advantageously provide an image scanner which is capable of acquiring an image of a card by using the adapter for an image scanner.

According to at least an embodiment of the present invention, there may be provided an adapter for an image scanner, the image scanner being structured to convey a card of a predetermined standard along a conveyance path and read images of a front surface and a back surface of the card, and the adapter being structured so that a front surface and a back surface of a card-shaped medium thinner than the card of the predetermined standard are read by the image scanner. The adapter for an image scanner includes a first sheet which is transparent and longer than a length dimension in a conveyance direction of the card of the predetermined standard, and the card-shaped medium being placed on a front surface of the first sheet, a spacer having a constant thickness which is transparent and fixed to at least one of a front end portion and a rear end portion in the conveyance direction of the front surface of the first sheet, and a second sheet which is transparent and fixed to the spacer so as to be overlapped with the first sheet, and the second sheet covering the card-shaped medium from an opposite side to the first sheet.

According to at least an embodiment of the present invention, a card-shaped medium is held by the adapter for an image scanner in a state sandwiched between the first sheet and the second sheet. Therefore, even when a shape of the card-shaped medium is uneven, clogging of the card-shaped medium is not occurred during conveyance and the card-shaped medium is not damaged. Further, since the first sheet and the second sheet are laminated through the spacer, the card-shaped medium is easily disposed between the first sheet and the second sheet. In addition, the first sheet, the spacer and the second sheet are transparent and thus the image scanner is capable of reading the front surface and the back surface of the card-shaped medium. In this case, when the image scanner includes a transmission type photo sensor structured to detect a card on the conveyance path, the card-shaped medium held by the transparent adapter for an image scanner is capable of intercepting a detection light of the transmission type photo sensor. Therefore, the card-shaped medium on the conveyance path can be detected by the transmission type photo sensor structured to detect a card of a predetermined standard.

In at least an embodiment of the present invention, a dimension of the first sheet in an orthogonal direction perpendicular to the conveyance direction and a dimension of the second sheet in the orthogonal direction are the same as a dimension of the card of the predetermined standard in the orthogonal direction. According to this structure, the adapter for an image scanner is easily conveyed along the conveyance path for conveying a card of a predetermined standard.

In at least an embodiment of the present invention, the spacer is a double sided tape. According to this structure, the first sheet and the second sheet are adhesively fixed to each other by the spacer.

In at least an embodiment of the present invention, a front end edge of the first sheet is extended in the orthogonal direction, a front end edge of the second sheet is extended in the orthogonal direction and, when viewed in a laminated direction of the first sheet and the second sheet, the front end edge of the first sheet and the front end edge of the second sheet are coincided with each other, and the spacer is fixed along the front end edge of the first sheet and is extended in the orthogonal direction on the front surface of the first sheet. According to this structure, when a card-shaped medium is disposed along the spacer, the card-shaped medium is easily set in a posture so that its front end edge is extended in the orthogonal direction along the front end edge of the first sheet and the front end edge of the second sheet.

In at least an embodiment of the present invention, the adapter further includes a second spacer which is fixed to the rear end portion of the first sheet, the second spacer is fixed along a rear end edge of the first sheet and is extended in the orthogonal direction on the front surface of the first sheet, and a distance between the spacer and the second spacer in the conveyance direction is longer than a length dimension in the conveyance direction of the card of the predetermined standard. According to this structure, the card-shaped medium can be inserted in the orthogonal direction between the first sheet and the second sheet.

In at least an embodiment of the present invention, a front end portion of the first sheet or a front end portion of the second sheet is provided with a light shielding part. According to this structure, in a case that the image scanner includes a transmission type photo sensor for detecting a card on the conveyance path, a detection light of the transmission type photo sensor can be intercepted by the light shielding part. Therefore, the adapter for an image scanner on the conveyance path can be detected by the transmission type photo sensor for detecting a card of a predetermined standard.

In at least an embodiment of the present invention, the light shielding part is a black printed part on the first sheet or the second sheet. According to this structure, the light shielding part is easily provided on the first sheet or the second sheet. Further, when a black printed part is provided, at least a visible light is intercepted.

In at least an embodiment of the present invention, the light shielding part is provided on the first sheet, and the light shielding part is extended in the conveyance direction from the front end edge of the first sheet and is reached to an opposite side to the front end edge of the spacer. According to this structure, when a card-shaped medium is disposed on the first sheet along the spacer, a front end of the card-shaped medium can be overlapped with the light shielding part. As a result, a transparent space is prevented from being formed between the card-shaped medium and the light shielding part and thus a front end of the adapter for an image scanner on the conveyance path can be surely detected by the transmission type photo sensor.

In at least an embodiment of the present invention, the first sheet is provided with a second light shielding part at a separated position from the light shielding part in the conveyance direction, a distance between the light shielding part and the second light shielding part is shorter than a length dimension in the conveyance direction of the card of the predetermined standard, and a distance between the light shielding part and an end of the second light shielding part on an opposite side to the light shielding part is longer than a length dimension in the conveyance direction of the card of the predetermined standard. According to this structure, it can be grasped that the adapter for an image scanner has passed through a detection position of the transmission type photo sensor at a time when interception of an inspection light of the transmission type photo sensor by the second light shielding part is released. Further, according to this structure, when a front surface and a back surface of a card-shaped medium held by the adapter for an image scanner are read by the image scanner, a range of an image of the card-shaped medium can be grasped through the second light shielding part shown in the image. Therefore, an unnecessary region is easily omitted from the image data and only a required image portion is cut out from the read image and thus the volume of image data is easily restrained.

In at least an embodiment of the present invention, the first sheet is provided with a first notched part which is extended in the conveyance direction from the front end edge and is reached to an opposite side to the front end edge of the spacer, the spacer is provided with one side spacer portion located on one side in the orthogonal direction with respect to the first notched part and an other side spacer portion located on the other side in the orthogonal direction with respect to the first notched part, and the second sheet is provided with a second notched part overlapping with the notched part when viewed in the laminated direction of the first sheet and the second sheet. According to this structure, a front end edge of the card-shaped medium sandwiched between the first sheet and the second sheet can be exposed outside from the adapter for an image scanner through the first notched part and the second notched part. Therefore, in a case that the image scanner includes a transmission type photo sensor for detecting a card on the conveyance path, a detection light of the transmission type photo sensor can be intercepted by a front end edge of the card-shaped medium. Accordingly, the front end part of the card-shaped medium on the conveyance path can be detected by a transmission type photo sensor.

In at least an embodiment of the present invention, at least one of the first sheet and the second sheet is provided with a scale attached with a fixed interval in the conveyance direction. According to this structure, in a case that an operator touches a card-shaped medium while the image scanner is reading an image of the card-shaped medium to cause the medium speed uneven and to occur a malfunction such as distortion of a read image, the distortion is detected based on deformation of the image of the scale in the read image and the distortion can be notified to the operator. Further, even in a case that a medium speed becomes uneven caused by aged deterioration or dirt of the conveyance roller and the like and thus a malfunction such as distortion of a read image is occurred, the distortion can be detected based on deformation of the image of the scale in the read image and the distortion can be notified to the operator. In addition, when the scale is provided in the adapter for an image scanner, the conveyance speed can be checked whether it is normal or not by making the scanner read an image of the adapter for an image scanner at the time of maintenance of the image scanner.

In at least an embodiment of the present invention, the first sheet or the second sheet is provided with a third notched part at a halfway position in the conveyance direction. According to this structure, a card-shaped medium is easily inserted into between the first sheet and the second sheet. Further, the card-shaped medium is easily taken out from between the first sheet and the second sheet.

In at least an embodiment of the present invention, the second sheet is provided with a guide part structured to dispose a symbol string described on a face on the second sheet side of the card-shaped medium placed on the first sheet at a predetermined position. According to this structure, a position and a posture of the card-shaped medium sandwiched between the first sheet and the second sheet are easily determined.

In at least an embodiment of the present invention, the guide part is a straight line which is printed on the second sheet so as to be extended in the conveyance direction, a straight line which is printed on the second sheet so as to be extended in the orthogonal direction, or a frame line which is printed on the second sheet so as to be capable of surrounding the symbol string. According to this structure, the guide part is easily provided. Further, when the guide part printed on the second sheet is provided, the guide part is shown in the image which is read from the card-shaped medium. Therefore, only a required region of image data is easily extracted with the guide part in the image as a reference. Accordingly, a processing time of image is reduced.

In at least an embodiment of the present invention, each of the first sheet and the second sheet does not transmit a visible light and transmits infrared rays. According to this structure, in a case that personal information and the like are described on a front surface and a back surface of a card-shaped medium, or the like, when the card-shaped medium is held by the adapter for an image scanner, the personal information is prevented from being known by a third person.

In this case, it may be structured that the second sheet is provided with a guide part structured to dispose a symbol string described on a face on the second sheet side of the card-shaped medium placed on the first sheet at a predetermined position, and the guide part is an opening part formed in the second sheet and capable of exposing the symbol string from the second sheet. According to this structure, even when the first sheet and the second sheet do not transmit a visible light, a position and a posture of the card-shaped medium sandwiched between the first sheet and the second sheet are easily determined. Further, information required to identify a card-shaped medium can be recognized through the opening part in a state that the card-shaped medium has been inserted into the adapter for an image scanner.

Next, according to at least an embodiment of the present invention, there may be provided an image scanner including the above-mentioned adapter for an image scanner, a conveyance path structured to convey the card of the predetermined standard, a conveyance mechanism structured to convey the adapter which holds the card-shaped medium thinner than the card along the conveyance path, a first image sensor and a second image sensor which are disposed on either side so as to sandwich the conveyance path, a transmission type photo sensor structured to detect the adapter or the card-shaped medium on an upstream side in the conveyance direction with respect to a first image reading position by the first image sensor and a second image reading position by the second image sensor, and a control part structured to drive the first image sensor and the second image sensor based on a signal from the transmission type photo sensor and read an image of a first face on the first sheet side of the card-shaped medium passing through the first image reading position and read an image of a second face on the second sheet side of the card-shaped medium passing through the second image reading position. Each of the first image sensor and the second image sensor irradiates the adapter conveyed on the conveyance path with an image reading light of a visible light.

According to the image scanner in accordance with at least an embodiment of the present invention, a card-shaped medium is conveyed along the conveyance path for conveying a card of a predetermined standard in a state held by the adapter for an image scanner. Therefore, even when a shape of the card-shaped medium is uneven, the image scanner does not occur clogging of the card-shaped medium during conveyance and the card is not damaged. Further, the image scanner drives the first image sensor and the second image sensor based on an output from the transmission type photo sensor which are disposed on an upstream side in the conveyance direction with respect to the first image reading position and the second image reading position. Therefore, a front surface and a back surface of the card-shaped medium passing through the first image reading position and the second image reading position can be read by the first image sensor and the second image sensor.

Further, according to at least an embodiment of the present invention, there may be provided an image scanner including the above-mentioned adapter for an image scanner in which the first sheet and the second sheet do not transmit a visible light and transmit infrared rays, a conveyance path structured to convey the card of the predetermined standard, a conveyance mechanism structured to convey the adapter which holds the card-shaped medium thinner than the card along the conveyance path, a first image sensor and a second image sensor which are disposed on either side so as to sandwich the conveyance path, a transmission type photo sensor structured to detect the adapter or the card-shaped medium on an upstream side in the conveyance direction with respect to a first image reading position by the first image sensor and a second image reading position by the second image sensor, and a control part structured to drive the first image sensor and the second image sensor based on a signal from the transmission type photo sensor and read an image of a first face on the first sheet side of the card-shaped medium passing through the first image reading position and read an image of a second face on the second sheet side of the card-shaped medium passing through the second image reading position. Each of the first image sensor and the second image sensor irradiates the adapter conveyed on the conveyance path with an image reading light of infrared rays.

According to the image scanner in accordance with at least an embodiment of the present invention, a card-shaped medium is conveyed along the conveyance path for conveying a card of a predetermined standard in a state held by the adapter for an image scanner. Therefore, even when a shape of the card-shaped medium is uneven, the image scanner does not occur clogging of the card-shaped medium during conveyance and the card is not damaged. Further, the image scanner drives the first image sensor and the second image sensor based on an output from the transmission type photo sensor which are disposed on an upstream side in the conveyance direction with respect to the first image reading position and the second image reading position. Therefore, a front surface and a back surface of the card-shaped medium passing through the first image reading position and the second image reading position can be read by the first image sensor and the second image sensor. In addition, image reading lights emitted from the first image sensor and the second image sensor are infrared rays and thus, even when the first sheet and the second sheet do not transmit a visible light and transmit infrared rays, a front surface image and a back surface image of the card-shaped medium can be acquired.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outward perspective view showing an image scanner to which the present invention is applied.

FIG. 2 is a perspective view showing an image scanner from which an outer case is detached.

FIG. 3 is a longitudinal cross-sectional view showing an image scanner.

FIG. 4 is a schematic block diagram showing a control system of an image scanner.

FIG. 5 is an explanatory view showing a paper card (notification card).

FIG. 6 is an explanatory view showing an adapter for an image scanner in accordance with an embodiment of the present invention.

FIG. 7 is an explanatory view showing an adapter for an image scanner in a first modified embodiment.

FIG. 8 is an explanatory view showing an adapter for an image scanner in a second modified embodiment.

FIG. 9 is an explanatory view showing an adapter for an image scanner in a third modified embodiment.

FIG. 10 is an explanatory view showing an adapter for an image scanner in an eighth modified embodiment.

FIG. 11 is an explanatory view showing an adapter for an image scanner in a ninth modified embodiment.

FIG. 12A and FIG. 12B are explanatory views showing an adapter for an image scanner in a tenth modified embodiment.

### DETAILED DESCRIPTION

(Image Scanner)

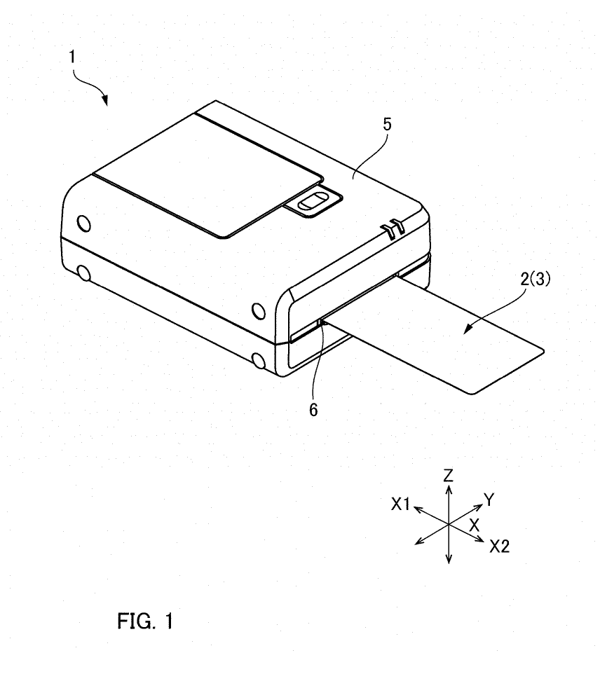

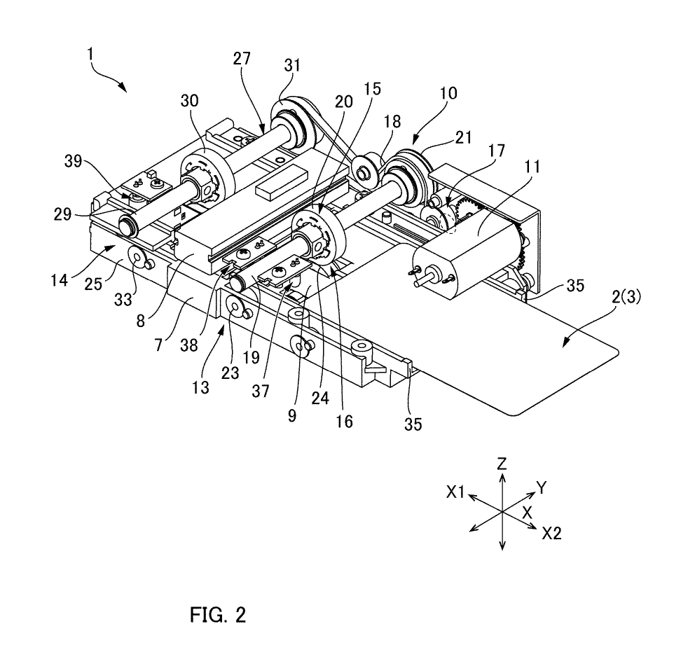

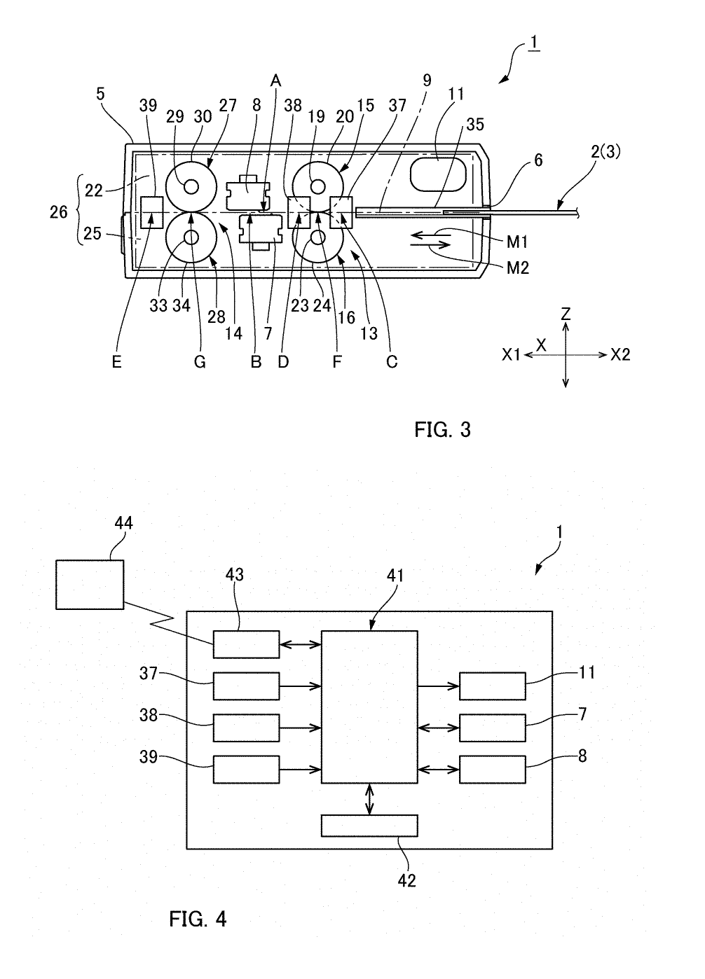

FIG. 1 is an outward perspective view showing an image scanner to which the present invention is applied. FIG. 2 is a perspective view showing an image scanner from which an outer case is detached. FIG. 3 is a longitudinal cross-sectional view showing an image scanner. FIG. 4 is a schematic block diagram showing a control system of an image scanner. A scanner 1 (image scanner) in this embodiment reads a front surface and a back surface of a card having the same shape as a credit card and the like of the ID-1 (JIS ID-1: predetermined standard) of ISO standards (hereinafter, referred to as an ISO card 2). In the ID-1 of ISO standards, a length dimension, a width dimension and a thickness dimension of a card are prescribed to be 85.60 mm, 53.98 mm and 0.76 mm. Further, the scanner 1 in this embodiment reads a front surface and a back surface of a paper card 4 (card-shaped medium) whose thickness dimension is thinner than an ISO card 2 by using an adapter 3 (adapter for an image scanner) described below.

As shown in FIG. 1, the scanner 1 includes a housing 5 formed in a rectangular parallelepiped shape and a slot 6 provided in a rear face of the housing 5. As shown in FIG. 2, an inside of the housing 5 includes a first image sensor 7, a second image sensor 8, a conveyance path 9 where an ISO card 2 is conveyed, and a conveyance mechanism 10 structured to convey the ISO card 2 and an adapter 3 along the conveyance path 9.

The first image sensor 7 and the second image sensor 8 are disposed on both upper and lower sides with the conveyance path 9 interposed therebetween. As shown in FIG. 3, the conveyance path 9 is extended in a straight line shape from the slot 6 so as to pass a first image reading position “A” of the first image sensor 7 and a second image reading position “B” of the second image sensor 8 in this order. In the following descriptions, an extended direction of the conveyance path 9 is referred to as a front and rear direction “X” of the scanner 1. An orthogonal direction perpendicular to the upper and lower direction “Z” and the front and rear direction “X” is referred to as a width direction “Y” of the scanner 1. Further, in the front and rear direction “X”, a side where the conveyance path 9 is extended from the slot 6 is referred to as a front side “X1”, and the opposite side is referred to as a rear side “X2”. Further, in the front and rear direction “X”, a direction that the conveyance mechanism 10 conveys an ISO card 2 and an adapter 3 when an image is to be read (direction directing to the front side “X1” from the slot 6) is referred to as a conveying direction “M1”, and the opposite direction is referred to as an ejecting direction “M2”.

Each of the first image sensor 7 and the second image sensor 8 is a line image sensor. Each of the first image sensor 7 and the second image sensor 8 is disposed in a posture across the conveyance path 9 in the width direction “Y”. The first image sensor 7 is located on a lower side with respect to the conveyance path 9 and its sensor face is directed to the conveyance path 9 (upper side). The second image sensor 8 is located on an upper side with respect to the conveyance path 9 and its sensor face is directed to the conveyance path 9 (lower side). The first image sensor 7 images (reads) a rear surface (under face) of a card-shaped medium passing through the first image reading position “A”, and the second image sensor 8 images (reads) a front surface (upper face) of the card-shaped medium passing through the second image reading position “B”.

Each of the first image sensor 7 and the second image sensor 8 is capable of reading of an image by a visible light, an infrared light and an ultraviolet light. In other words, each of the first image sensor 7 and the second image sensor 8 emits a visible light, an infrared light and an ultraviolet light selectively or in order as an image reading light to an ISO card 2 or the like which is conveyed in the conveyance path 9, and a visible light image, an infrared light image, an ultraviolet light image can be acquired.

As shown in FIG. 2, the conveyance mechanism 10 includes a conveyance motor 11 as a drive source. Further, the conveyance mechanism 10 includes a first conveyance roller pair 13 disposed on the rear side “X2” (upstream side in the conveying direction “M1”) with respect to the first image sensor 7 and the second image sensor 8 and a second conveyance roller pair 14 disposed on the front side “X1”.

The first conveyance roller pair 13 includes a first drive roller 15 located on an upper side with respect to the conveyance path 9 and a first driven roller 16 located on a lower side with respect to the conveyance path 9. Rotation of the conveyance motor 11 is transmitted to the first drive roller 15 through a drive force transmission mechanism 17. The drive force transmission mechanism 17 includes a belt 18. The first drive roller 15 includes a first drive shaft 19 extended in the width direction “Y”, a first drive roller main body 20 fixed to a center portion in the width direction “Y” of the drive shaft, and a first pulley 21 provided at one end in the width direction “Y” of the first drive shaft 19. The first drive shaft 19 is rotatably supported by an upper side frame 22 (see FIG. 3). Rotation of the conveyance motor 11 is transmitted to the first pulley 21 through the belt 18. The first driven roller 16 includes a first rotation shaft 23 extended in the width direction “Y” and a first driven roller main body 24 fixed to a center portion in the width direction “Y” of the first rotation shaft 23. The first rotation shaft 23 is rotatably supported by a lower side frame 25. In this embodiment, the upper side frame 22 is fixed on an upper side of the lower side frame 25, and the upper side frame 22 and the lower side frame 25 structure a frame 26.

The second conveyance roller pair 14 includes a second drive roller 27 located on an upper side with respect to the conveyance path 9 and a second driven roller 28 located on a lower side with respect to the conveyance path 9. Rotation of the conveyance motor 11 is transmitted to the second drive roller 27 through the drive force transmission mechanism 17. The second drive roller 27 includes a second drive shaft 29 extended in the width direction “Y”, a second drive roller main body 30 fixed to a center portion in the width direction “Y” of the second drive shaft 29, and a second pulley 31 provided at one end in the width direction “Y” of the second drive shaft 29. The second drive shaft 29 is rotatably supported by the upper side frame 22. Rotation of the conveyance motor 11 is transmitted to the second pulley 31 through a belt of the drive force transmission mechanism 17. As shown in FIG. 3, the second driven roller 28 includes a second rotation shaft 33 extended in the width direction “Y” and a second driven roller main body 34 fixed to a center portion in the width direction “Y” of the second rotation shaft 33. The second rotation shaft 33 is rotatably supported by the lower side frame 25.

In this embodiment, a dimension in an orthogonal direction to the conveyance path 9 is substantially equal to a width dimension of an ISO card 2. As shown in FIG. 2, conveyance guide parts 35 structured to control and guide an ISO card 2 so as to be linearly conveyed are provided on both sides in the orthogonal direction of the conveyance path 9 in the lower side frame 25.

Further, the scanner 1 are provided with a first position sensor 37, a second position sensor 38 and a third position sensor 39 for detecting an ISO card 2 located on the conveyance path 9. The first position sensor 37 is located on a rear side “X2” with respect to the first drive shaft 19. In other words, a first detection position “C” of the first position sensor 37 is located on an upstream side in the conveying direction “M1” with respect to a first nip position “F” of an ISO card 2 by the first conveyance roller pair 13. The second position sensor 38 is located between the first drive shaft 19 and the first image sensor 7. In other words, a second detection position “D” of the second position sensor 38 is located on an upstream side in the conveying direction “M1” with respect to the first image reading position “A” of the first image sensor 7 and is located on a downstream side with respect to the first nip position “F”. The third position sensor 39 is located on the front side “X1” with respect to the second drive shaft 29. In other words, a third detection position “E” of the third position sensor 39 is located on a downstream side in the conveying direction “M1” with respect to the second image reading position “B” of the second image sensor 8 and a second nip position “G” by the second conveyance roller pair 14.

The first position sensor 37, the second position sensor 38 and the third position sensor 39 are respectively transmission type photo sensors. Each of the first position sensor 37, the second position sensor 38 and the third position sensor 39 includes a light emitting part which emits an inspection light and a light receiving part which receives the inspection light. The light emitting part and the light receiving part are disposed on an upper side and a lower side with the conveyance path 9 interposed therebetween. When an ISO card 2 or the like conveyed along the conveyance path 9 is passed through the detection positions of the respective sensors and the inspection lights are respectively intercepted by the ISO card 2 or the like, each of the first position sensor 37, the second position sensor 38 and the third position sensor 39 outputs a signal that an ISO card 2 has been detected.

In addition, the scanner 1 includes a control part 41. As shown in FIG. 4, the first position sensor 37, the second position sensor 38 and the third position sensor 39 are connected with an input side of the control part 41. The conveyance motor 11 is connected with an output side of the control part 41. Further, the first image sensor 7, the second image sensor 8 and a memory 42 are connected with the control part 41. In addition, the control part 41 is connected with a host apparatus 44 through a communication interface 43.

The control part 41 drives and controls the conveyance motor 11, the first image sensor 7 and the second image sensor 8 based on outputs from the first position sensor 37 and the second position sensor 38 to acquire front surface image data which are a front surface image read from a front surface of an ISO card 2 and back surface image data which are a back surface image read from its back surface. Further, the control part 41 stores and holds the acquired front surface image data and the acquired back surface image data in the memory 42. In addition, the control part 41 transmits appropriate image data of the front surface image data and the back surface image data memorized in the memory 42 to the host apparatus 44 depending on an instruction from the host apparatus 44.

(Image Reading Operation)

When an ISO card 2 is inserted into the conveyance path 9 through the slot 6 and is reached to the first detection position “C”, an inspection light of the first position sensor 37 is intercepted by a front end part of the ISO card 2. Therefore, a signal that the ISO card 2 has been detected is outputted from the first position sensor 37 and thus the control part 41 drives the conveyance motor 11. As a result, the first conveyance roller pair 13 and the second conveyance roller pair 14 are rotated and the ISO card 2 is conveyed along the conveyance path 9 in the conveying direction “M1” (front side “X1”).

After that, when the ISO card 2 is reached to the second detection position “D”, an inspection light of the second position sensor 38 is intercepted by the front end part of the conveyed ISO card 2. Therefore, since a signal that the ISO card 2 has been detected is outputted from the second position sensor 38, the control part 41 drives and controls the first image sensor 7 and the second image sensor 8 to perform reading of the front surface and the back surface of the ISO card 2 being conveyed. When the ISO card 2 is to be read, each of the first image sensor 7 and the second image sensor 8 irradiates the ISO card 2 conveyed through each image reading position (the first image reading position “A” and the second image reading position “B”) with an image reading light by a predetermined reading time period and the front surface image data and the back surface image data are acquired. The reading time period is a period sufficient for the ISO card 2 to pass through the first image reading position “A” and the second image reading position “B”. Further, as described below, the reading time period is a period sufficient for a paper card 4 held by an adapter 3 to pass through the first image reading position “A” and the second image reading position “B”. The control part 41 stores and holds the front surface image data and the back surface image data acquired by the first image sensor 7 and the second image sensor 8 in the memory 42. In addition, the control part 41 transmits appropriate image data of the front surface image data and the back surface image data memorized in the memory 42 to the host apparatus 44 depending on an instruction from the host apparatus 44.

After that, the control part 41 stops the conveyance motor 11 when a predetermined conveying time period has elapsed after the conveyance motor 11 is driven. After that, the control part 41 drives the conveyance motor 11 in a reverse direction. Therefore, in the scanner 1, the ISO card 2 is conveyed in the ejecting direction “M2” (rear side “X2”) and ejects it from the slot 6. In this embodiment, a predetermined conveying time period is a period that a rear end in the conveying direction “M1” of the ISO card 2 is capable of passing through the second image reading position “B” of the second image sensor 8 by the conveyance motor 11. Further, as described below, the predetermined conveying time period is the period that an adapter 3 is capable of passing through the second image reading position “B” of the second image sensor 8. In this embodiment, in a case that the control part 41 stops the conveyance motor 11 and drives it in the reverse direction, the third position sensor 39 has detected the ISO card 2 at the third detection position “E”. Therefore, the control part 41 has confirmed that the ISO card 2 is located on the conveyance path 9 based on an output from the third position sensor 39.

(Adapter)

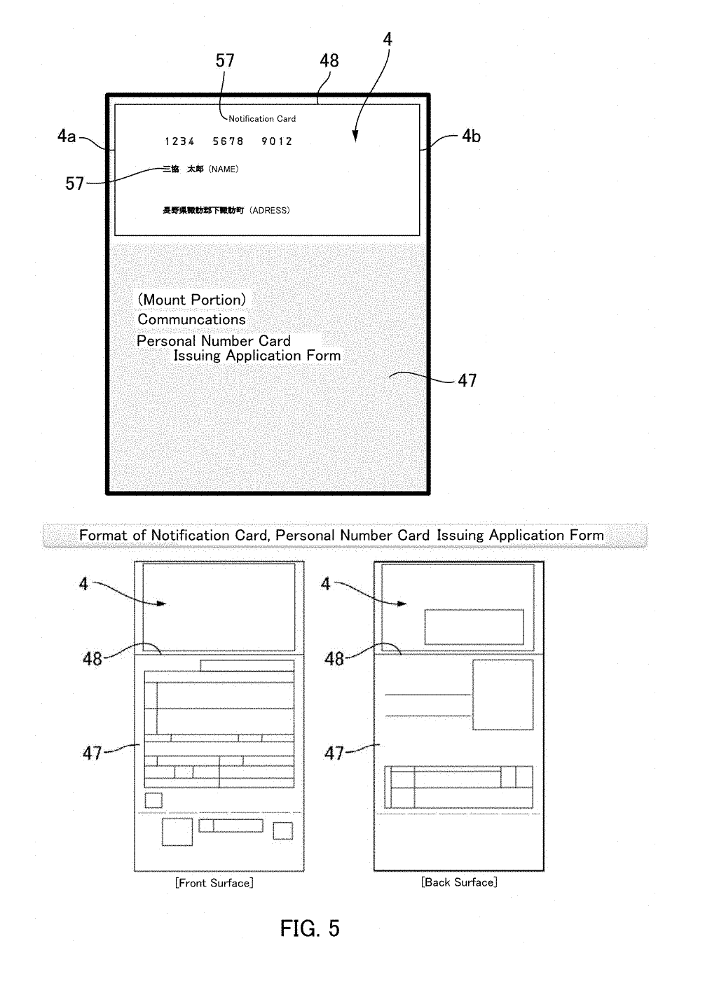

Next, an adapter 3 (adapter for an image scanner) will be described below which is used when a front surface and a back surface of a card-shaped medium whose thickness is thinner than that of an ISO card 2 are read by the scanner 1. First, a paper card 4 (card-shaped medium) which is thinner than an ISO card 2 is, for example, a notification card of my-number. FIG. 5 is an explanatory view showing a notification card of my-number

A paper card 4 (notification card) is a medium printed in a mount portion of a mount 47 and is surrounded by a cut line 48 formed in a card shape. A user cuts out the inner side along the cut line 48 and uses it as a paper card 4 (card-shaped medium). A thickness dimension of the paper card 4 is in a range from 0.1 mm to 0.2 mm.

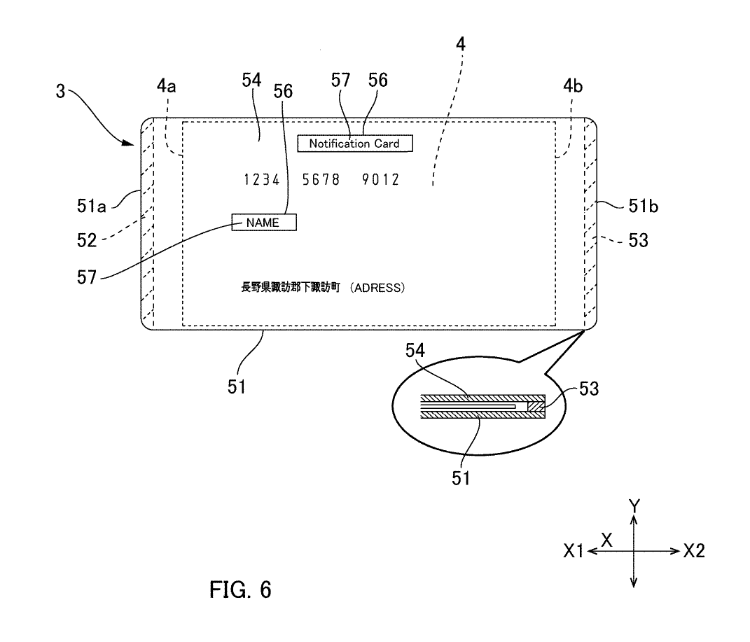

FIG. 6 is a plan view showing an adapter 3 in accordance with a first embodiment of the present invention in a state that a paper card 4 is mounted. The adapter 3 is structured so that two rectangular transparent sheets made of resin or the like whose dimension in a short width direction is equal to a shorter-side width of the ISO card 2 are adhered to each other at two short side portions or one short side portion. An adhered part of the two sheets in the adapter 3 is structured so that a thickness dimension of the entire adapter 3 is set to be equal to or less than a thickness of an ISO card 2 and, in addition, two sheets are fixed to each other with a spacer (intermediate member) therebetween so as to secure a gap space in which a paper card 4 is capable of being mounted (see, the enlarged view in FIG. 6). The entire length in a longitudinal direction of the adapter 3 is set to be longer than an ISO card 2.

A longitudinal direction of the adapter 3 is the front and rear direction “X” of the adapter 3 which is inserted to the conveyance path 9. In the following descriptions, a longitudinal direction of the adapter 3 is referred to as the front and rear direction “X” (conveying direction “M1”), a downstream side (front side) in the conveying direction “M1” is referred to as the front side “X1” of the adapter 3 in the front and rear direction “X”, and the opposite side is referred to as the rear side “X2” of the adapter 3. Further, the short width direction of the adapter 3 is the width direction “Y” of the adapter 3 inserted into the conveyance path 9. Therefore, in the following descriptions, the short width direction of the adapter 3 is referred to as the width direction “Y”. The width direction “Y” is an orthogonal direction perpendicular to the front and rear direction (conveying direction “M1”).

More specifically, the adapter 3 includes a first transparent sheet 51 whose front surface is placed with a paper card 4, a first transparent spacer 52 having a constant thickness which is fixed to a front end portion of the front surface of the first sheet 51, a second transparent spacer 53 with a constant thickness which is fixed to a rear end portion of the front surface of the first sheet 51, and a second transparent sheet 54 which is fixed to the first spacer 52 and the second spacer 53 and is overlapped with the first sheet 51 so as to cover the paper card 4 from an opposite side to the first sheet 51. The first sheet 51 is a resin sheet and has flexibility. A planar shape of the first sheet 51 is rectangular as a whole and the four corners are formed in a curved shape. A front end edge 51a and a rear end edge 51b of the first sheet 51 are extended in the width direction “Y”. A length dimension in the front and rear direction “X” (conveying direction “M1”) of the first sheet 51 is longer than a length dimension in the front and rear direction “X” of an ISO card 2. A width dimension in the width direction “Y” of the first sheet 51 is the same as a width dimension in the width direction “Y” of the ISO card 2. The total dimension which is obtained by totaling the thicknesses of the first sheet 51, the first spacer 52 (or the second spacer 53) and the second sheet 54 is equal to or less than a thickness dimension of the ISO card 2.

The first spacer 52 is fixed along the front end edge 51a of the first sheet 51 and is extended in the width direction “Y” on the front surface of the first sheet 51. The second spacer 52 is fixed along the rear end edge of the first sheet 51 and is extended in the width direction “Y” on the front surface of the first sheet 51. Each of the first spacer 52 and the second spacer 53 is a transparent double sided tape. A distance between the first spacer 52 and the second spacer 53 in the front and rear direction “X” is longer than a length dimension in the front and rear direction “X” of an ISO card 2. In accordance with an embodiment of the present invention, the first spacer 52 and the second spacer 53 are not limited to a double sided tape. For example, each of the first spacer 52 and the second spacer 53 may be formed of a sheet made of transparent resin and fixed to the first sheet 51 and the second sheet 54 with an adhesive or attached by press-contacting.

The second sheet 54 is a resin sheet and has flexibility. The second sheet 54 is formed in the same shape as the first sheet 51. When viewed in a laminated direction of the first sheet 51 and the second sheet 54, the second sheet 54 is completely overlapped with the first sheet 51 and an outer circumferential edge of the first sheet 51 and an outer circumferential edge of the second sheet 54 are coincided with each other.

The adapter 3 is provided with guide parts 56 for positioning which are used as a reference for a mounting position of the paper card 4 by silk printing. On the other hand, the paper card 4 is printed with a symbol string 57 (positioning mark) for positioning at predetermined positions. The symbol string 57 may be an arbitrary character string and symbols when capable of being recognized visually through the guide part 56. In this embodiment, the guide part 56 is formed in a frame shape surrounding the symbol string 57.

In other words, the second sheet 54 is provided with the guide part 56 for disposing the symbol string 57 described on the face on the second sheet 54 side of the paper card 4 placed on the first sheet 51 at a predetermined position. In this embodiment, as shown in FIG. 6, the guide part 56 is a frame line printed on the second sheet 54 which is capable of surrounding a specific character string (symbol string 57).

The paper card 4 is inserted in the width direction “Y” into a space sectioned by the first sheet 51, the second sheet 54, the first spacer 52 and the second spacer 53 and is set in a sandwiched state between the first sheet 51 and the second sheet 54 in a laminated direction of the first sheet 51 and the second sheet 54. In this embodiment, the first spacer 52 is extended along the front end edge 51a of the first sheet 51 and the front end edge of the second sheet 54. Therefore, when the paper card 4 is inserted into between the first sheet 51 and the second sheet 54 along the first spacer 52, the paper card 4 can be easily set in a posture that the front end edge of the paper card 4 is extended in the width direction “Y” along the front end edge 51a of the first sheet 51 and the front end edge of the second sheet 54.

Further, when the paper card 4 is inserted into between the first sheet 51 and the second sheet 54 and the predetermined character string of the paper card 4 is disposed on an inner side of the guide part 56 (frame line) of the second sheet 54, the position and the posture of the paper card 4 can be determined in the adapter 3.

In this embodiment, the paper card 4 is cut out from the mount 47 in a size so as to be fitted to an inside of the adapter 3. However, when the paper card 4 is roughly cut out, the paper card 4 may be protruded outside from the adapter 3 in the width direction “Y”. In this case, the protruded end is folded to be set between the first sheet 51 and the second sheet 54.

(Image Reading Operation)

The adapter 3 structured as described above is inserted into the slot 6 of the scanner 1 in a state that a paper card 4 is disposed between the first sheet 51 and the second sheet 54. In this case, when the adapter 3 is inserted into the conveyance path 9 through the slot 6 to reach the first detection position “C”, an inspection light of the first position sensor 37 is intercepted by a front end part of the paper card 4 which is held by the adapter 3. In other words, since the adapter 3 (first sheet 51, first spacer 52, second spacer 53 and second sheet 54) is transparent, the inspection light of the first position sensor 37 is intercepted by the paper card 4. Therefore, a signal that the paper card 4 has been detected is outputted from the first position sensor 37 and thus, the control part 41 drives the conveyance motor 11 to rotate the first conveyance roller pair 13 and the second conveyance roller pair 14 and convey the adapter 3 which holds the paper card 4 to the front side “X1” along the conveyance path 9.

Next, when the adapter 3 reaches the second detection position “D”, an inspection light of the second position sensor 38 is intercepted by the front end part of the paper card 4 having been conveyed. As a result, a signal that the paper card 4 has been detected is outputted from the second position sensor 38 and thus, the control part 41 drives and controls the first image sensor 7 and the second image sensor 8 to perform reading of the front surface and the back surface of the paper card 4 having been conveyed. In this case, each of the first image sensor 7 and the second image sensor 8 irradiates the paper card 4 conveyed through each of the image reading positions (first image reading position “A” and second image reading position “B”) with an image reading light by a predetermined reading time period to acquire front surface image data and back surface image data. The reading time period is set to be a sufficient time period that the adapter 3 is capable of passing through the first image reading position “A” and the second image reading position “B”. Further, the control part 41 stores and holds the front surface image data and the back surface image data in the memory 42 and transmits appropriate image data to the host apparatus 44 depending on an instruction from the host apparatus 44.

After that, when a predetermined conveying time period has elapsed after the conveyance motor 11 is driven, the control part 41 stops the conveyance motor 11 and, after that, the control part 41 drives the conveyance motor 11 in a reverse direction. Therefore, the scanner 1 ejects the adapter 3 which holds the paper card 4 through the slot 6. In this embodiment, the predetermined conveying time period is a period that the paper card 4 held by the adapter 3 is capable of passing through the second image reading position “B” of the second image sensor 8. Further, when the conveyance motor 11 is to be stopped by the control part 41, a signal that the paper card 4 has been detected is outputted from the third position sensor 39 and the control part 41 has confirmed that the paper card 4 is located on the conveyance path 9.

(Operations and Effects)

A dimension in the width direction “Y” of the adapter 3 is similar to that of an ISO card 2. Therefore, similarly to an ISO card 2, the adapter 3 is conveyed along the conveyance path 9 by the conveyance mechanism 10 of the scanner 1. Further, when the adapter 3 is to be conveyed, the adapter 3 is controlled and guided by the conveyance guide parts 35 so as to be conveyed linearly.

Further, the paper card 4 is held by the adapter 3 in a state sandwiched between the first sheet 51 and the second sheet 54. Therefore, even if a shape of the paper card 4 is uneven, clogging of the paper card 4 is not occurred during conveyance and the paper card 4 is not damaged. In addition, the first sheet 51 and the second sheet 54 are laminated each other through the spacers 52 and 53 and thus the paper card 4 is easily disposed between the first sheet 51 and the second sheet 54. Further, the first sheet 51, the spacers 52 and 53 and the second sheet 54 are transparent and thus the scanner 1 can read a front surface and a back surface of the paper card 4.

The adapter 3 is provided with the guide part 56 printed on the second sheet 54 and thus the guide part 56 is shown in the front surface image having been read from the front surface of the paper card 4. Therefore, only a required region of the front surface image data is easily extracted with the guide part 56 in the front surface image as a reference. Accordingly, an image processing time can be shortened.

In addition, when the adapter 3 is used, the following effects can be obtained.

(1) Since the adapter 3 is utilized which is capable of processing a paper card 4 even in a case that the paper card 4 is roughly cut out, image reading of high quality can be executed without damaging the paper card 4 at a low cost.
(2) A dedicated paper punch is not required to prepare in a place where the scanner 1 is used.
(3) A required image can be scanned without damaging a paper card 4 of a customer.
(4) A physical change of the scanner 1 itself is unnecessary. Further, only when control software is changed and a reading time period and a conveying time period are changed, the scanner 1 can be diverted to other models and its versatility is high.
(5) Clogging of a paper card 4 and image distortion are prevented and thus reading quality is improved.
(6) The adapter 3 has a simple structure and thus a manufacturing cost of the adapter 3 is low.

In accordance with an embodiment of the present invention, the guide part 56 may be structured of a straight line which is printed on the second sheet 54 so as to be extended in the front and rear direction “X”. For example, like an underline for the symbol string 57, the guide part 56 may be structured of a straight line extending in the front and rear direction “X” along the symbol string 57. In addition, the guide part 56 may be a straight line which is printed on the second sheet 54 so as to extend in the width direction “Y”. Further, the guide part 56 may be structured of a carved mark or a hole. In addition, the guide part 56 may be provided on the first sheet 51. Further, the guide part 56 may be provided on both of the first sheet 51 and the second sheet 54.

Further, it may be structured that no second spacer 53 is provided. In this case, when a rear end portion of the first sheet 51 and a rear end portion of the second sheet 54 are separated from each other, a paper card 4 can be inserted into between the first sheet 51 and the second sheet 54. Therefore, a paper card 4 is easily mounted on the adapter 3.

In this embodiment, the adapter 3 is provided with adhered parts using the first spacer 52 and the second spacer 53 on the front side and the rear side with respect to the paper card 4 and thus a length in the front and rear direction “X” (longitudinal direction) of the adapter 3 is longer than that of an ISO card 2. Therefore, in order to read the entire image, an image data size becomes large and processing time becomes long, and communication time of image data transmission to the host apparatus 44 may become long. However, a necessary image to be processed is different depending on desired business processing and thus, when only required image data are cut out and processed without using other image data, an image data size is reduced and a processing time can be shortened. For example, in a case that the paper card 4 is a notification card shown in FIG. 5, a reading prohibited region (information) is determined under regulations and, in addition, required information, i.e., image information to be read for counter processing in a bank is limited. Therefore, when a required portion of necessary information is set by a positioning mark and a frame of the guide part 56 of the adapter 3 is provided so as to correspond to the portion of the necessary information, only the image within the frame of the guide part 56 can be read and other image data outside the guide part 56 can be omitted. Accordingly, an image data size to be processed is reduced and image processing time can be shortened.

### First Modified Embodiment

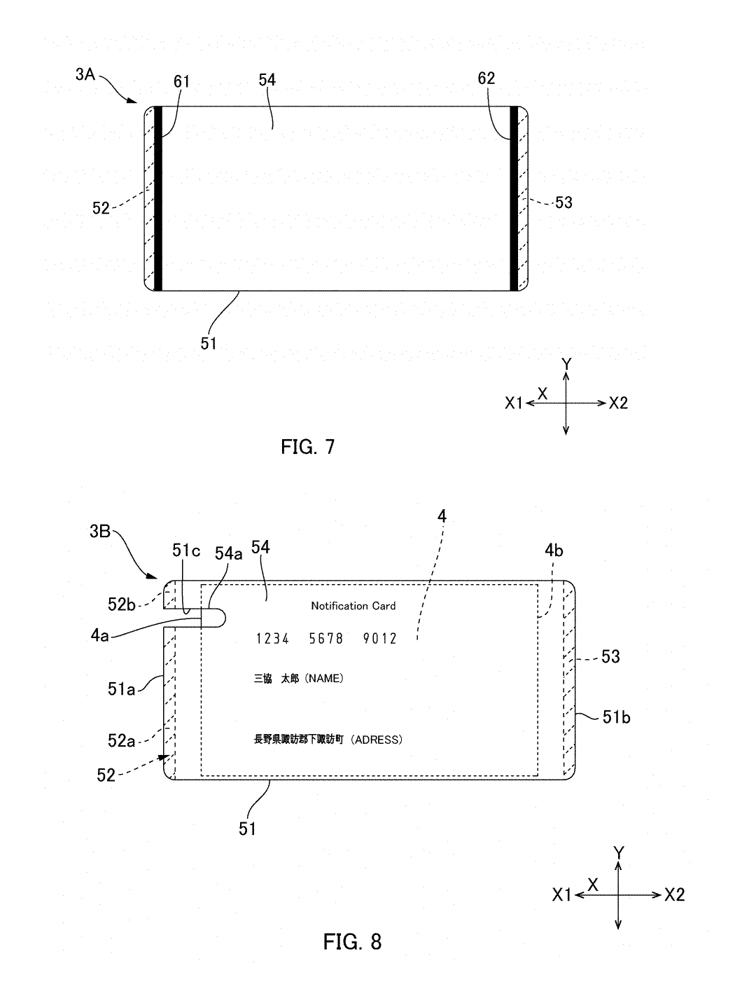

FIG. 7 is a plan view showing an adapter 3A in accordance with a first modified embodiment of the present invention. The adapter 3A in this embodiment is provided with a first light shielding part 61 (start mark) and a second light shielding part 62 (end mark) in the adapter 3 described above. According to this structure, the scanner 1 is capable of recognizing a length of a medium further accurately. The adapter 3A in the first modified embodiment 1 includes the structures corresponding to the adapter 3 in the first embodiment except the first light shielding part 61 and the second light shielding part 62. Therefore, the first light shielding part 61 and the second light shielding part 62 will be described below and other descriptions are omitted.

The first light shielding part 61 is provided in a front end portion of the first sheet 51. More specifically, the first light shielding part 61 is extended in the width direction “Y” with a constant width at a position adjacent on the rear side “X2” to the first spacer 52. The first light shielding part 61 is a black stripe printed on the first sheet 51 by silk printing or the like. The second light shielding part 62 is provided in a rear end portion of the first sheet 51. More specifically, the second light shielding part 62 is extended in the width direction “Y” with a constant width at a position adjacent on the front side “X1” to the second spacer 53. The second light shielding part 62 is a black stripe printed on the first sheet 51 by silk printing or the like.

Also in this embodiment, a dimension in the width direction “Y” of the adapter 3A is similar to that of an ISO card 2 and thus, similarly to the ISO card 2, the adapter 3A is conveyed along the conveyance path 9 by the conveyance mechanism 10 of the scanner 1. Further, the paper card 4 is held by the adapter 3A in a state sandwiched between the first sheet 51 and the second sheet 54. Therefore, even if a shape of the paper card 4 is uneven, clogging of the paper card 4 is not occurred during conveyance and the paper card 4 is not damaged. In addition, the first sheet 51 and the second sheet 54 are laminated through the first spacer 52 and the second spacer 53 and thus the paper card 4 is easily disposed between the first sheet 51 and the second sheet 54. Further, a portion of the adapter 3A overlapping with a portion of the paper card 4 required to read an image is transparent and thus the scanner 1 is capable of reading a front surface and a back surface of the paper card 4.

In addition, in this embodiment, the first sheet 51 is provided with the first light shielding part 61 and thus, when the adapter 3A holding a paper card 4 is conveyed along the conveyance path 9 of the scanner 1, detection lights of the respective sensors can be intercepted by the first light shielding part 61. Therefore, the adapter 3A in the conveyance path 9 can be detected.

Further, in this embodiment, when a front surface and a back surface of a paper card 4 held in the adapter 3A are read by the scanner 1, a range of an image of the paper card 4 can be grasped by the first light shielding part 61 and the second light shielding part 62 which are shown in the image. Therefore, an unnecessary region is easily omitted from the image data and only a necessary image portion is cut out from the image data to easily restrain volume of the image data.

In accordance with an embodiment of the present invention, the first light shielding part 61 and the second light shielding part 62 may be provided on the second sheet 54. Further, similarly to the embodiment described above, the guide part 56 may be provided in the first sheet 51 and the second sheet 54, and the second spacer 53 may be omitted.

### Second Modified Embodiment

FIG. 8 is a plan view showing an adapter 3B in a second modified embodiment. The adapter 3B in this embodiment is provided with a notch at a detection position for the respective position sensors 37, 38 and 39. As a result, a front end edge of a paper card 4 can be directly detected by the respective position sensors 37, 38 and 39 and thus erroneous detection by an optical sensor for an end part of the adapter 3B which is transparent can be avoided. (When the adapter 3B is detected by the adhered part at the end part, the adapter 3B may be erroneously recognized to be a long card). The adapter 3B in the second modified embodiment includes the structures corresponding to the adapter 3 described above and thus the corresponding structures are indicated by the same reference signs and their descriptions are omitted.

More specifically, in the adapter 3B in this embodiment, the first sheet 51 is provided with a first notch 51c in its front end portion. The first notch 51c is extended from a front end edge 51a of the first sheet 51 in the front and rear direction “X” to be reached to a rear side “X2” with respect to the first spacer 52 (opposite side to the front end edge 51a). The first spacer 52 includes one side spacer portion 52a located on one side with respect to the first notch 51c in the width direction “Y” and the other side spacer portion 52b located on the other side with respect to the first notch 51c in the width direction “Y”. The second sheet 54 is provided with a second notch 54a overlapping with the first notch 51c when viewed in a laminated direction of the first sheet 51 and the second sheet 54. In this embodiment, the formed positions of the first notch 51c and the second notch 54a in the adapter 3B are set at positions where the inspection lights of the respective position sensors 37, 38 and 39 are irradiated when the adapter 3B is conveyed along the conveyance path 9. Further, lengths of the first notched part 51c and the second notched part 54a in the front and rear direction “X” are set so that, when a paper card 4 is sandwiched between the first sheet 51 and the second sheet 54, the front end edge 4a of the paper card 4 is exposed outside from the adapter 3B through the first notched part 51c and the second notched part 54a.

According to this structure, the front end edge 4a of the paper card 4 sandwiched between the first sheet 51 and the second sheet 54 is exposed outside from the adapter 3B through the first notch 51c and the second notch 54a. Therefore, the inspection lights of the respective position sensors 37, 38 and 39 of the scanner 1 can be intercepted by the front end edge 4a of the paper card 4 exposed from the adapter 3B. Accordingly, the front end edge 4a of the paper card 4 on the conveyance path 9 can be detected by a transmission type photo sensor. Further, also in this embodiment, the guide part 56 may be provided in the first sheet 51 and the second sheet 54, and the second spacer 53 may be omitted.

### Third Modified Embodiment

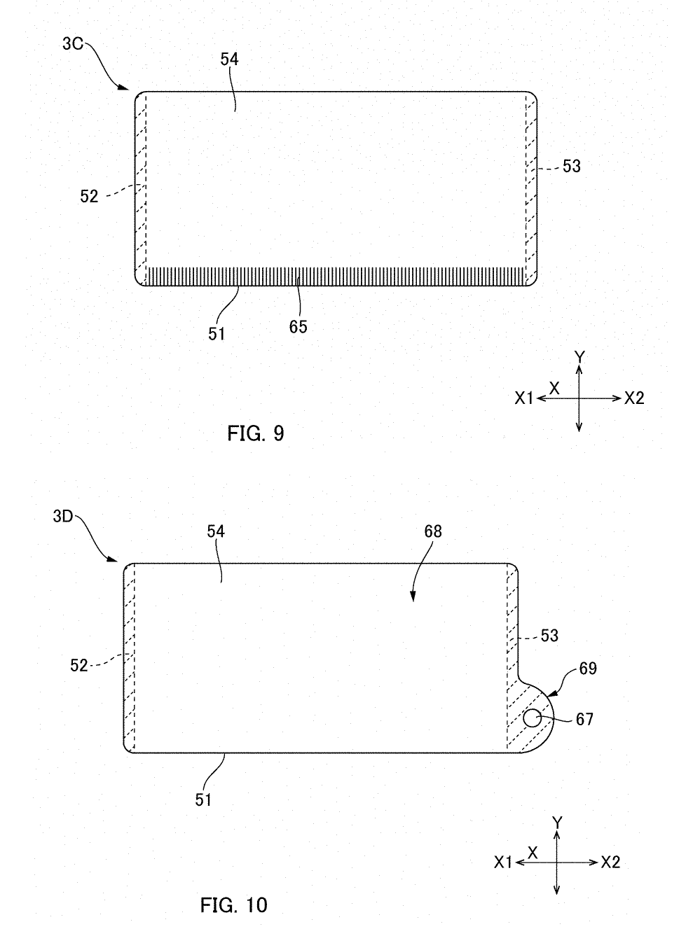

FIG. 9 is a plan view showing an adapter 3C in a third modified embodiment. The adapter 3C in this embodiment is provided with an encoder mark (constant-interval zebra pattern or the like) on one side or both sides of a front face and a back face of the adapter 3 in the first embodiment. In other words, the adapter 3C in this embodiment is provided with a scale 65 attached with a fixed interval in the front and rear direction “X” to at least one of the first sheet 51 and the second sheet 54.

According to this embodiment, in a case that an operator touches a card-shaped medium while the scanner 1 is reading an image of the card-shaped medium and a medium speed becomes uneven and a malfunction such as distortion of a read image is occurred, the distortion is detected based on deformation of the image of the scale 65 in the read image and the distortion can be notified to the operator. Further, even in a case that a medium speed becomes uneven caused by aged deterioration or dirt of the conveyance roller and the like to occur a malfunction such as distortion of a read image, the distortion can be detected based on deformation of the image of the scale 65 in the read image and the distortion can be notified to the operator. In addition, when the scale 65 is provided in the adapter 3C for an image scanner, the conveyance speed can be checked whether it is normal or not by making the scanner 1 read an image of the adapter 3C for the image scanner at the time of maintenance of the scanner 1. In accordance with an embodiment of the present invention, the scale 65 of the adapter 3C in the third modified embodiment may be adopted in the embodiment described above and other modified embodiments.

### Forth Modified Embodiment

In an adapter 3 in a fourth modified embodiment, a length in the front and rear direction “X”, in other words, a distance dimension between the adhered parts on both ends (distance between the first spacer 52 and the second spacer 53) is set to be further longer. According to this structure, a paper card 4 whose width is the same as an ISO card 2, but whose length is longer than the ISO card 2 is capable of being read. For example, in a case of the paper card 4, even in a card in which only one side is cut out to separate a notification portion, the image can be read without damaging the paper card 4.

### Fifth Modified Embodiment

In an adapter 3 in a fifth modified embodiment, descriptions and cautions in a method of using the adapter 3B are printed on a back surface, a blank region or a region out of an object to be read. The information may be simultaneously printed together with the guide parts 56 to the first sheet 51 and the second sheet 54.

### Sixth Modified Embodiment

In an adapter 3 in a sixth modified embodiment, scratch prevention processing is performed on the first sheet 51 and the second sheet 54. The scratch prevention processing includes, for example, processing that each of the first sheet 51 and the second sheet 54 is coated with transparent resin material whose hardness is higher than those of the first sheet 51 and the second sheet 54.

### Seventh Modified Embodiment

In an adapter 3 in a seventh embodiment, the first sheet 51 and the second sheet 54 are formed of material through which infrared rays are transmitted but a visible light is not transmitted. Materials through which infrared rays are transmitted but a visible light is not transmitted include, for example, resin contained with black dye-based color material. Further, the second sheet 54 is provided with an opening part corresponding to the frame line as the guide part 56. In other words, the second sheet 54 is provided as the guide part 56 with an opening part through which the symbol string 57 is exposed outside from the second sheet 54.

According to this embodiment, in a case that a paper card 4 is a notification card or the like, a user of the device such as a person in charge in a public government office can be prevented from viewing the personal information. In other words, in a case that personal information or the like is described on a front surface and a back surface of a paper card 4, when the paper card 4 is held by the adapter 3, the information can be avoided from being known by a third person. Further, the guide part 56 is formed to be an opening part and thus, even in a case that the first sheet 51 and the second sheet 54 do not transmit a visible light, when a symbol string 57 is exposed from the guide part 56 (opening part), the position and the posture of a card-shaped medium sandwiched between the first sheet 51 and the second sheet 54 can be determined. In this embodiment, the opening part may be formed by punching a hole in the sheet at a printed position of information other than the personal information (symbol string 57 such as “Notification Card” shown in FIG. 5).

On the other hand, in a case that the adapter 3 in this embodiment is used, infrared rays are used as image reading lights of the first image sensor 7 and the second image sensor 8 in the scanner 1. According to this structure, infrared images of the front surface and the back surface of a paper card 4 can be acquired by the first image sensor 7 and the second image sensor 8.

Alternatively, the first sheet 51 and the second sheet 54 of the adapter 3 may be formed of material which transmits ultraviolet rays but does not transmit a visible light. In this case, ultraviolet rays are used as image reading lights of the first image sensor 7 and the second image sensor 8 and thereby ultraviolet images of the front surface and the back surface of a paper card 4 can be acquired without personal information being known by a third person. In addition, a member which transmits infrared rays or ultraviolet rays but does not transmit a visible light may be used in only portions of the first sheet 51 and the second sheet 54 which covers personal information which does not want to be known by a third person.

### Eighth Modified Embodiment

FIG. 10 is a plan view showing an adapter 3D in an eighth modified embodiment. The adapter 3D in this embodiment is provided with a hook hole 67 at one end of the adapter 3D so that the adapter 3D is held by a hook. More specifically, each of the first sheet 51 and the second sheet 54 is provided with a rectangular shaped portion 68 which is longer than a length dimension in the front and rear direction “X” of an ISO card 2 and a protruded portion 69 which is protruded to the rear side “X2” from the rectangular shaped portion 68, and the protruded portion 69 is provided with the hook hole 67. In a state that the first sheet 51 and the second sheet 54 are laminated, the hook hole 67 of the first sheet 51 and the hook hole 67 of the second sheet 54 are overlapped with each other.

According to this structure, in a case that the adapter 3D is stored or the like, the adapter 3D can be engaged with a hook or the like. In accordance with an embodiment of the present invention, the protruded portion 69 and the hook hole 67 may be provided in only one of the first sheet 51 and the second sheet 54.

### Ninth Modified Embodiment

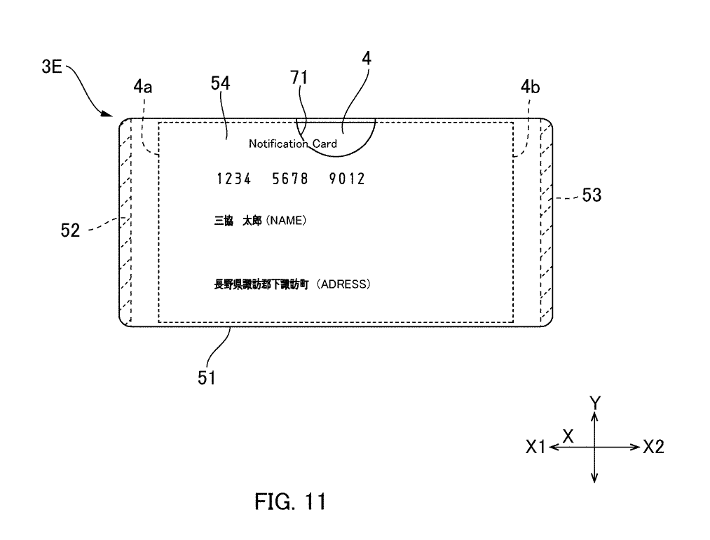

FIG. 11 is a plan view showing an adapter 3E in a ninth modified embodiment. The adapter 3E in this embodiment is provided with a holding part 71 which is formed by cutting out a part of one of two transparent sheets so that a paper card 4 can be easily put in and out. In other words, the second sheet 54 is provided on the way in the front and rear direction “X” with the holding part 71 (third notch) which is extended from one end edge in the width direction “Y” to a side of the other end edge.

According to this embodiment, a paper card 4 disposed between the first sheet 51 and the second sheet 54 can be touched through the holding part 71. Therefore, the paper card 4 is easily inserted into between the first sheet 51 and the second sheet 54. Further, the paper card 4 is easily taken out from between the first sheet 51 and the second sheet 54.

### Tenth Modified Embodiment

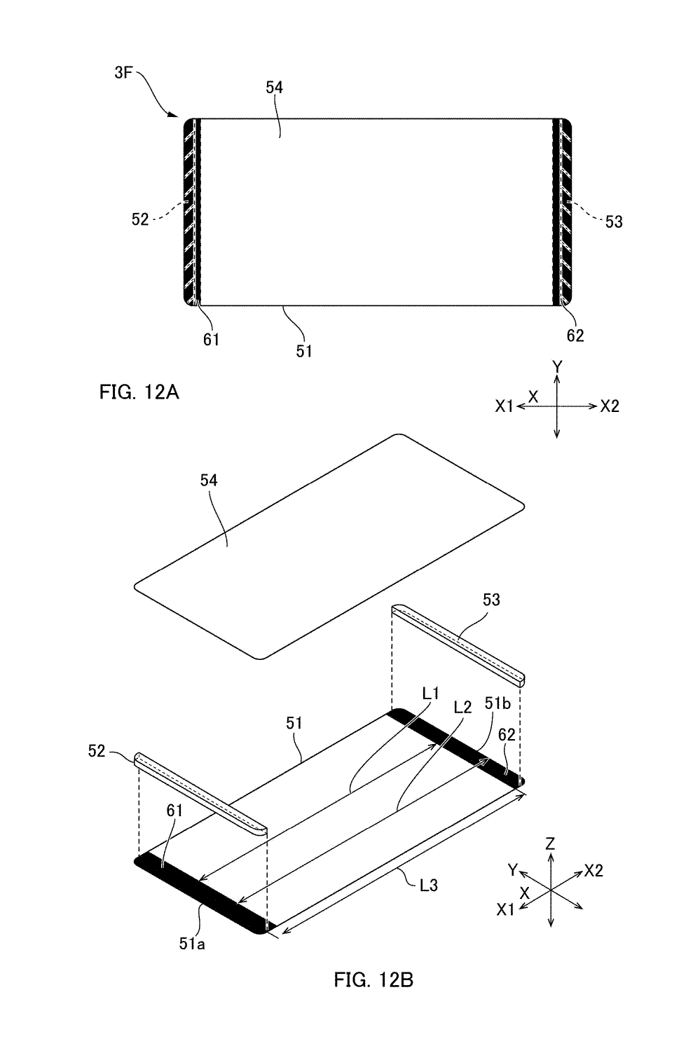

FIG. 12A is a plan view showing an adapter 3F in a tenth modified embodiment, and FIG. 12B is an exploded perspective view showing the adapter 3F in the tenth modified embodiment. The adapter 3F in this embodiment includes a first transparent sheet 51 whose front surface is placed with a paper card 4, a first transparent spacer 52 having a constant thickness which is fixed to a front end portion of the front surface of the first sheet 51, a second transparent spacer 53 having a constant thickness which is fixed to a rear end portion of the front surface of the first sheet 51, and a second transparent sheet 54 which is fixed to the first spacer 52 and the second spacer 53 and is overlapped with the first sheet 51 so as to cover the entire paper card 4 from an opposite side to the first sheet 51. The adapter 3F in this embodiment includes the structures corresponding to the adapter 3 in the first embodiment and thus the corresponding structures are indicated by the same reference signs.

The first sheet 51 is a resin sheet and has flexibility. A planar shape of the first sheet 51 is rectangular as a whole and the four corners are formed in a curved shape. A front end edge 51a and a rear end edge 51b of the first sheet 51 are extended in the width direction “Y”. A length dimension in the front and rear direction “X” of the first sheet 51 is longer than a length dimension in the front and rear direction “X” of an ISO card 2. A width dimension in the width direction “Y” of the first sheet 51 is the same as a width dimension in the width direction “Y” of the ISO card 2.

The first spacer 52 is fixed along the front end edge 51a of the first sheet 51 and is extended in the width direction “Y” on the front surface of the first sheet 51. The second spacer 52 is fixed along the rear end edge of the first sheet 51 and is extended in the width direction “Y” on the front surface of the first sheet 51. Each of the first spacer 52 and the second spacer 53 is a transparent double sided tape. A distance between the first spacer 52 and the second spacer 53 in the front and rear direction “X” is longer than a length dimension in the front and rear direction “X” of the ISO card 2.

The second sheet 54 is a resin sheet and has flexibility. The second sheet 54 is formed in the same shape as the first sheet 51. When viewed in a laminated direction of the first sheet 51 and the second sheet 54, the second sheet 54 is completely overlapped with the first sheet 51 and an outer circumferential edge of the first sheet 51 and an outer circumferential edge of the second sheet 54 are coincided with each other.

A first light shielding part 61 is provided in a front end portion of the first sheet 51. The first light shielding part 61 is extended in the front and rear direction “X” from the front end edge 51a of the first sheet 51 and is reached to the rear side “X2” with respect to the first spacer 52 (opposite side to the front end edge 51a). Further, the first light shielding part 61 is extended in the width direction “Y” along the front end edge 51a of the first sheet 51. The first light shielding part 61 is a black stripe printed on the first sheet 51 by silk printing. The second light shielding part 62 is provided in a rear end portion of the first sheet 51. More specifically, the second light shielding part 62 is extended in the front and rear direction “X” from the rear end edge 51b of the first sheet 51 and is reached to the front side “X1” with respect to the second spacer 53 (opposite side to the rear end edge 51b). The second light shielding part 62 is extended in the width direction “Y” along the rear end edge 51b of the first sheet 51. The second light shielding part 62 is a black stripe printed on the first sheet 51 by silk printing.

In this embodiment, a distance “L1” between the first light shielding part 61 and the second light shielding part 62 is shorter than a length dimension in the front and rear direction “X” of an ISO card 2 (paper card 4). Further, a distance “L2” between the first light shielding part 61 and an end of the second light shielding part 62 on an opposite side to the first light shielding part 61 is longer than a length dimension in the front and rear direction “X” of the ISO card 2 (paper card 4). Therefore, when a paper card 4 is disposed between the first sheet 51 and the second sheet 54, a front end of the paper card 4 can be overlapped with the first light shielding part 61 and a rear end of the paper card 4 is overlapped with the second light shielding part 62. In addition, in this embodiment, a distance “L3” between the spacer 52 and the second light shielding part 62 is shorter than a length dimension in the front and rear direction “X” of the ISO card 2 (paper card 4). Therefore, when a paper card 4 is disposed adjacent to the spacer 52, a front end of the paper card 4 is overlapped with the first light shielding part 61 and a rear end of the paper card 4 is overlapped with the second light shielding part 62.

Also in this embodiment, a dimension in the width direction “Y” of the adapter 3F is similar to that of an ISO card 2 and thus, similarly to an ISO card 2, the adapter 3F is conveyed along the conveyance path 9 by the conveyance mechanism of the scanner 1. Further, the paper card 4 is held by the adapter 3F in a state sandwiched between the first sheet 51 and the second sheet 54. Therefore, even if a shape of the paper card 4 is uneven, clogging of the paper card 4 is not occurred during conveyance and the paper card 4 is not damaged. In addition, the first sheet 51 and the second sheet 54 are laminated through the first spacer 52 and the second spacer 53 and thus the paper card 4 is easily disposed between the first sheet 51 and the second sheet 54. Further, a portion of the adapter 3F overlapping with a portion of the paper card 4 where an image is required to be read is transparent and thus the scanner 1 is capable of reading a front surface and a back surface of the paper card 4.

Further, in this embodiment, the first sheet 51 is provided with the first light shielding part 61 and thus, when the adapter 3F holding a paper card 4 is conveyed along the conveyance path 9 of the scanner 1, detection lights of the respective position sensors 37, 38 and 39 can be intercepted by the first light shielding part 61. Therefore, a front end of the adapter 3F on the conveyance path 9 can be detected. Further, since the first light shielding part 61 and a front end edge 4a of the paper card 4 can be overlapped with each other, a transparent space is prevented from being formed between the paper card 4 and the first light shielding part 61. Therefore, erroneous detection of the position sensors 37 and 38 can be avoided and thus the position of the front end of the adapter 3F on the conveyance path 9 is surely detected by the respective position sensors 37, 38 and 39.

In addition, in this embodiment, since the second light shielding part 62 and a rear end edge 4b of the paper card 4 can be overlapped with each other, a transparent space is prevented from being formed between the paper card 4 and the second light shielding part 62. Therefore, at a time when interception of an inspection light of each of the position sensors 37, 38 and 39 by the second light shielding part 62 is released, it can be grasped that the adapter 3F has passed through the detection positions “C”, “D” and “E” by the respective position sensors 37, 38 and 39.

Further, when a front surface and a back surface of a paper card 4 held by the adapter 3F have been read by the scanner 1, a range of an image of the paper card 4 can be precisely grasped by the first light shielding part 61 and the second light shielding part 62 shown in the image. Therefore, it is easy to omit an unnecessary region from the image data and a volume of the image data is easily restrained by cutting out only necessary image from the image data.

In accordance with an embodiment of the present invention, the first light shielding part 61 and the second light shielding part 62 may be provided on the second sheet 54.

Further, in this embodiment, the second spacer 53 may be omitted. In this case, a rear end portion of the first sheet 51 and a rear end portion of the second sheet 54 are not fixed and thus a paper card 4 can be easily inserted into between the first sheet 51 and the second sheet 54. Also in this case, in this embodiment, a distance “L1” between the first light shielding part 61 and the second light shielding part 62 is shorter than a length dimension in the front and rear direction “X” of an ISO card 2 (paper card 4). Further, the second light shielding part 62 is extended in the front and rear direction “X” from the rear end edge 51b of the first sheet 51, and a distance “L2” between the first light shielding part 61 and an end of the second light shielding part 62 on an opposite side to the first light shielding part 61 (distance between the first light shielding part 61 and the rear end edge 51b of the first sheet 51) is longer than a length dimension in the front and rear direction “X” of the ISO card 2 (paper card 4). Therefore, when a paper card 4 is to be disposed between the first sheet 51 and the second sheet 54, the front end edge 4a of the paper card 4 is easily overlapped with the first light shielding part 61 and the rear end edge 4b of the paper card 4 is easily overlapped with the second light shielding part 62. Accordingly, a transparent space is prevented from being formed between the paper card 4 and the first light shielding part 61 and between the paper card 4 and the second light shielding part 62.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An adapter for use with an image scanner, the image scanner being structured to convey a card of a predetermined standard along a conveyance path and read images of a front surface and a back surface of the card, and the adapter being structured so that a front surface and a back surface of a card-shaped medium thinner than the card of the predetermined standard are read by the image scanner, the adapter comprising:
a first sheet which is transparent and longer than a length dimension in a conveyance direction of the card of the predetermined standard, and the card-shaped medium being placed on a front surface of the first sheet;
a spacer having a constant thickness which is transparent and fixed to at least one of a front end portion and a rear end portion in the conveyance direction of the front surface of the first sheet; and
a second sheet which is transparent and fixed to the spacer so as to be overlapped with the first sheet, and the second sheet covering the card-shaped medium from an opposite side to the first sheet.

2. The adapter for an image scanner according to claim 1, wherein a dimension of the first sheet in an orthogonal direction perpendicular to the conveyance direction and a dimension of the second sheet in the orthogonal direction are a same as a dimension of the card of the predetermined standard in the orthogonal direction.

3. The adapter for an image scanner according to claim 2, wherein the spacer is a double sided tape.

4. The adapter for an image scanner according to claim 2, wherein
a front end edge of the first sheet is extended in the orthogonal direction,
a front end edge of the second sheet is extended in the orthogonal direction,
when viewed in a laminated direction of the first sheet and the second sheet, the front end edge of the first sheet and the front end edge of the second sheet are coincided with each other, and
the spacer is fixed along the front end edge of the first sheet and is extended in the orthogonal direction on the front surface of the first sheet.

5. The adapter for an image scanner according to claim 4, further comprising a second spacer which is fixed to the rear end portion of the first sheet,
wherein the second spacer is fixed along a rear end edge of the first sheet and is extended in the orthogonal direction on the front surface of the first sheet, and
wherein a distance between the spacer and the second spacer in the conveyance direction is longer than a length dimension in the conveyance direction of the card of the predetermined standard.

6. The adapter for an image scanner according to claim 1, wherein a front end portion of the first sheet or a front end portion of the second sheet comprises a light shielding part.

7. The adapter for an image scanner according to claim 6, wherein the light shielding part is a black printed part on the first sheet or the second sheet.

8. The adapter for an image scanner according to claim 6, wherein
the light shielding part is provided on the first sheet, and
the light shielding part is extended in the conveyance direction from the front end edge of the first sheet to an opposite side to the front end edge of the spacer.

9. The adapter for an image scanner according to claim 8, wherein
the first sheet comprises a second light shielding part at a separated position from the light shielding part in the conveyance direction,
a distance between the light shielding part and the second light shielding part is shorter than a length dimension in the conveyance direction of the card of the predetermined standard, and
a distance between the light shielding part and an end of the second light shielding part on an opposite side to the light shielding part is longer than a length dimension in the conveyance direction of the card of the predetermined standard.

10. The adapter for an image scanner according to claim 4, wherein
the first sheet comprises a first notched part which is extended in the conveyance direction from the front end edge and is reached to an opposite side to the front end edge of the spacer,
the spacer comprises one side spacer portion located on one side in the orthogonal direction with respect to the first notched part and an other side spacer portion located on an other side in the orthogonal direction with respect to the first notched part, and
the second sheet comprises a second notched part overlapping with the notched part when viewed in the laminated direction of the first sheet and the second sheet.

11. The adapter for an image scanner according to claim 1, wherein at least one of the first sheet and the second sheet comprises a scale attached with a fixed interval in the conveyance direction.

12. The adapter for an image scanner according to claim 1, wherein the first sheet or the second sheet comprises a third notched part at a halfway position in the conveyance direction.

13. The adapter for an image scanner according to claim 1, wherein the second sheet comprises a guide part structured to dispose a symbol string described on a face on a side of the second sheet of the card-shaped medium placed on the first sheet at a predetermined position.

14. The adapter for an image scanner according to claim 13, wherein the guide part is one of:
a straight line which is printed on the second sheet so as to be extended in the conveyance direction,
a straight line which is printed on the second sheet so as to be extended in the orthogonal direction, and
a frame line which is printed on the second sheet so as to be capable of surrounding the symbol string.

15. The adapter for an image scanner according to claim 1, wherein each of the first sheet and the second sheet does not transmit a visible light and transmits infrared rays.

16. The adapter for an image scanner according to claim 15, wherein
the second sheet comprises a guide part structured to dispose a symbol string described on a face on a side of the second sheet of the card-shaped medium placed on the first sheet at a predetermined position, and
the guide part is an opening part formed in the second sheet and capable of exposing the symbol string from the second sheet.

17. An image scanner comprising:
the adapter for an image scanner defined in claim 1;
a conveyance path structured to convey the card of the predetermined standard;
a conveyance mechanism structured to convey the adapter which holds the card-shaped medium thinner than the card along the conveyance path;
a first image sensor and a second image sensor which are disposed on either side so as to sandwich the conveyance path;
a transmission type photo sensor structured to detect the adapter or the card-shaped medium on an upstream side in the conveyance direction with respect to a first image reading position by the first image sensor and a second image reading position by the second image sensor; and
a control part structured to drive the first image sensor and the second image sensor based on a signal from the transmission type photo sensor and read an image of a first face on a side of the first sheet of the card-shaped medium passing through the first image reading position and read an image of a second face on a side of the second sheet of the card-shaped medium passing through the second image reading position;
wherein each of the first image sensor and the second image sensor irradiates the adapter conveyed on the conveyance path with an image reading light of a visible light.

18. An image scanner comprising:
the adapter for an image scanner defined in claim 15;
a conveyance path structured to convey the card of the predetermined standard;
a conveyance mechanism structured to convey the adapter which holds the card-shaped medium thinner than the card along the conveyance path;
a first image sensor and a second image sensor which are disposed on either side so as to sandwich the conveyance path;
a transmission type photo sensor structured to detect the adapter or the card-shaped medium on an upstream side in the conveyance direction with respect to a first image reading position by the first image sensor and a second image reading position by the second image sensor; and
a control part structured to drive the first image sensor and the second image sensor based on a signal from the transmission type photo sensor and read an image of a first face on a side of the first sheet of the card-shaped medium passing through the first image reading position and read an image of a second face on a side of the second sheet of the card-shaped medium passing through the second image reading position;
wherein each of the first image sensor and the second image sensor irradiates the adapter conveyed on the conveyance path with an image reading light of infrared rays.
